(19) United States
(12) Patent Application Publication
(10) Pub. No.: US 2008/0155193 A1
(43) Pub. Date: Jun. 26, 2008

(54) STAGING METHOD FOR DISK ARRAY APPARATUS

(75) Inventors: Hidejiro DAIKOKUYA, Kawasaki (JP); Mikio Ito, Kawasaki (JP); Kazuhiko Ikeuchi, Kawasaki (JP); Shinya Mochizuki, Kawasaki (JP); Hideo Takahashi, Kawasaki (JP); Yoshihito Konta, Kawasaki (JP); Norihide Kubota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/864,091

(22) Filed: Sep. 28, 2007

(30) Foreign Application Priority Data
Dec. 22, 2006 (JP) 2006-345557

(51) Int. Cl. G06F 12/00

(52) U.S. Cl. 711/114; 711/E12.001

(57) ABSTRACT

To provide a staging method capable of detecting an error in data read from a disk device during staging, a disk array control apparatus 100 includes a data read unit 101 for reading data, a first reference data generation unit 102 for generating first reference data from the read data, a second reference data generation unit 103 for similarly generating second reference data, a true-false determination unit 104 for determining whether or not the data read by the data read unit 101 is correct, and a data write unit 105 for writing data to cache memory.

### BACKGROUND OF THE INVENTION

1. Field of the Invention

The present invention relates to a staging method used for a disk array apparatus.

2. Description of the Related Art

Generally, a disk array apparatus such as a RAID device etc. has cache memory between a disk array and a host interface to realize high-speed access etc. For example, a part of data on the disk array is held in the cache memory, and when the host issues a read or write request, access can be performed in a high speed by performing a read process or a write process first on the data in the cache memory.

When there is no data requested from the host in the cache memory, the requested data is read by performing a read process in the data on the disk array, and the data is written to the cache memory. Generally the process is called “staging”.

A disk device configuring the disk array (for example, a magnetic disk device etc.) has a problem that, due to a fault of a disk head, a medium surface, etc., data cannot be correctly written in a write process, incorrect data can be read in a read process, etc.

On the other hand, with a larger capacity of a disk array apparatus, RAID(redundant arrays of inexpensive disks) 6 has received attention as having higher reliability than RAID 5.

The RAID 6 can be reconstructed by arranging two types of parity (parity P and Q) that have the mathematically orthogonal relation on different disk devices although two disk devices become faulty in the same RAID group. For example, self-repair can be performed although a disk device becomes faulty while another faulty disk device is being rebuilt.

The disk array apparatus generally guarantees the correctness of data by adding information such as a CRC (cyclic redundancy check) code, a block ID, etc. to data.

However, for example, if there occurs a fault that cannot be written to a medium surface when a write is performed on the disk device, and it is mistakenly recognized that the writing process has been correctly terminated, then the error of the data cannot be detected when the data is read afterwards. That is, if the data normally read for any reason from the disk device is not correct, then a staging process is performed on the incorrect data, and the incorrect data is transferred as is to the host.

Japanese Published Patent Application No. 2001-100940 discloses an array verification method capable of performing array verification for a short time, reducing the load of the CPU, and suppressing the reduction of the disk access speed from an application.

Japanese Published Patent Application No. 2003-167689 discloses a parity processing method for a disk array apparatus appropriate for the parity process performed in confirming the parity consistency for detection of an abnormal condition of a disk device configuring a disk array, or in generating parity etc.

### SUMMARY OF THE INVENTION

The present invention has been developed to solve the above-mentioned problems and aims at providing a staging method capable of detecting an error of data read from a disk device during staging.

To solve the above-mentioned problems, the disk array control apparatus according to the present invention generates a first error correction code and a second error correction code from predetermined data, distributes and stores the predetermined data and the first and second error correction codes in a lower device, and holds a part of data stored in the lower device in cache memory. The apparatus includes: a data read unit for reading from the lower device, at a read request from an upper device, predetermined data including the requested data, a first error correction code and a second error correction code generated from the predetermined data; a first reference data generation unit for generating first reference data from the data read by the data read unit and predetermined excluding the requested data, and the first error correction code; a second reference data generation unit for generating second reference data from the data read by the data read unit and predetermined excluding the requested data, and the second error correction code; a true-false determination unit for comparing the requested data read by the data read unit, the first reference data, and the second reference data, and determining whether or not the requested data read by the data read unit is correct on a basis of a result of the comparison; and a data write unit for storing data recognized as correct data by the true-false determination unit in the cache memory.

According to the present invention, the disk array control apparatus reads predetermined including the data requested by an upper device (hereinafter referred to as requested data, and first and second error correction codes.

Then, the requested data is reconstructed from the predetermined data excluding the requested data and the first error correction code, and the result is defined as the first reference data. Similarly, the requested data is reconstructed from the predetermined data excluding the requested data and the second error correction code, and the result is defined as the second reference data.

Furthermore, the requested data, the first reference data, and the second reference data are compared, and it is determined whether or not the requested data is true. As a result, it can be correctly determined whether or not the data (requested data) read from the lower device is correct.

Since the data determined as correct data by the true-false determination unit is written to the cache memory, the reliability of the data stored in the cache memory by the staging process can be improved.

As described above, the present invention provides a staging method capable of detecting incorrect data read from a disk device during staging.

### BRIEF DESCRIPTION OF THE DRAWINGS

FIG. 1 is an explanatory view showing the principle of the staging method according to an embodiment of the present invention;

FIG. 2 shows an example of a configuration of the disk array control apparatus according to an embodiment of the present invention;

FIG. 3 shows the outline of the process of confirming the correctness of read data by the disk array control apparatus according to an embodiment of the present invention; and

FIG. 4 is a flowchart of a practical process of the staging of the disk array control apparatus according to an embodiment of the present invention.

### DESCRIPTION OF THE PREFERRED EMBODIMENTS

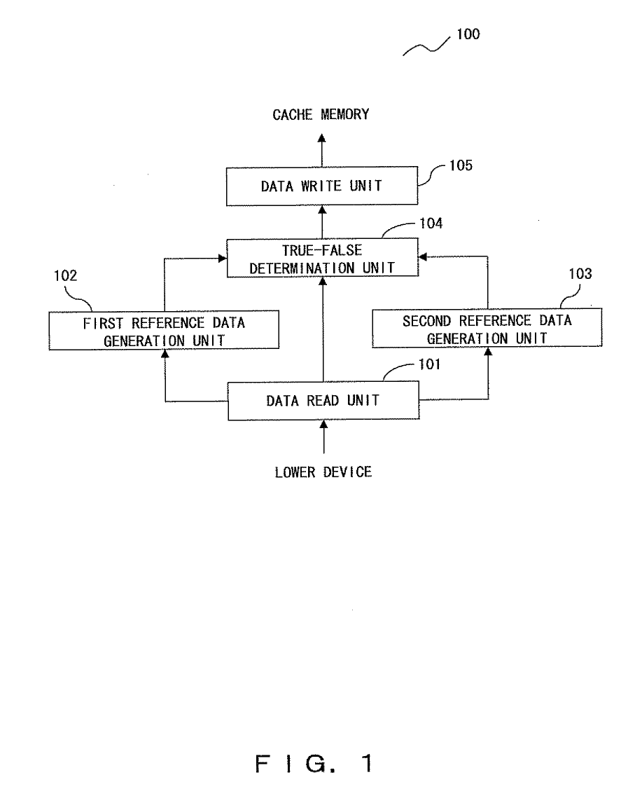

The embodiments of the present invention are described below by referring to FIGS. 1 through 4.

FIG. 1 is an explanatory view showing the principle of a disk array control apparatus 100 according to an embodiment of the present invention.

The disk array control apparatus 100 shown in FIG. 1 includes: a data read unit 101 for reading data: a first reference data generation unit 102 for generating first reference data from the read data; a second reference data generation unit 103 for similarly generating second reference data; a true-false determination unit 104 for determining whether or not the data read by the data read unit 101 is correct; and a data write unit 105 for writing data to cache memory.

The data read unit 101 reads predetermined data (hereinafter referred to as “data stripe”) from a lower device (for example, a disk array formed by a plurality of disk devices) that is connected to communicate with the disk array control apparatus 100.

The data stripe according to the present embodiment is configured by a series of data including desired data, a first error correction code, and a second error correction code. The first and second error correction codes are different error correction codes (for example, parity P and Q) generated from the series of data when the series of data is written to a lower device.

The first reference data generation unit 102 reconstructs the desired data from the first error correction code and the series of data excluding the desired data. The reconstructed data is defined as the first reference data.

Similarly, the second reference data generation unit 103 reconstructs the desired data from the second error correction code and the series of data excluding the desired data. The reconstructed data is defined as the second reference data.

The true-false determination unit 104 compares the desired data read by the data read unit 101, the first reference data generated by the first reference data generation unit 102, and the second reference data generated by the second reference data generation unit 103. On the basis of a result of the comparison, it is determined whether or not the desired data is correct.

In the present embodiment, when at least two of desired data, first reference data, and second reference data match, the matching data is recognized as correct data and a staging process is performed. If no data match, it is determined that the data is not correct, and the staging process abnormally terminates.

At least two of the data match, the matching data is recognized as correct data because, for example, when two pieces of data match, there is the remotest possibility that two disk devices simultaneously become faulty and the data of both devices similarly (in a matching state) become garbled as compared with the case in which one disk device becomes faulty.

The data write unit 105 writes the desired data recognized as correct data by the true-false determination unit 104 at a predetermined address of the cache memory.

In the above-mentioned process, for example, although incorrect data is stored as a result of a fault in a lower device, it can be determined whether or not the data read from the lower device is correct. Therefore, only correct data can be reflected by cache memory. That is, the staging process can be performed only on correct data.

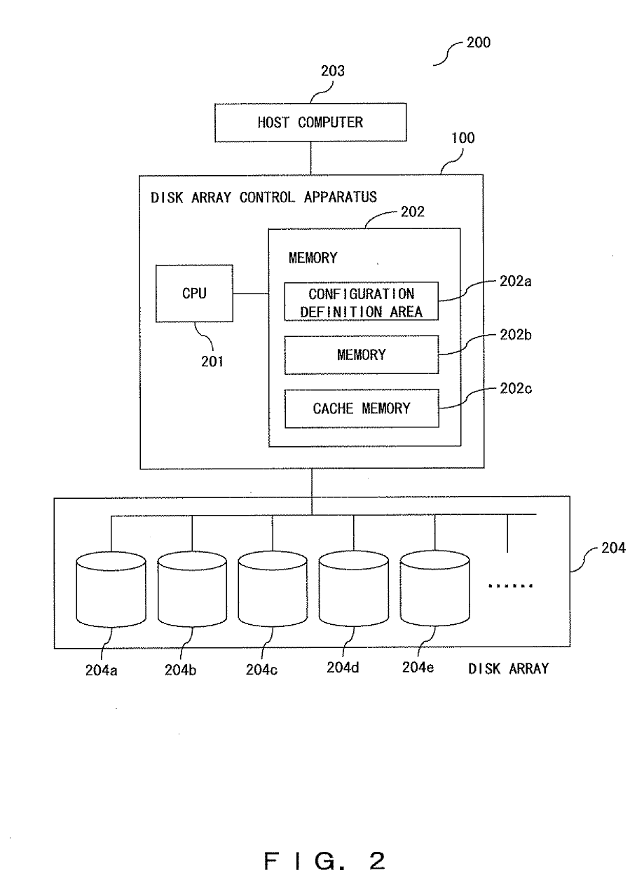

FIG. 2 shows an example of a practical configuration of the disk array control apparatus 100 according to an embodiment of the present invention.

The disk array control apparatus 100 shown in FIG. 2 includes at least a CPU 201 for realizing the disk array control apparatus according to the present embodiment by executing a predetermined program, and memory 202 for storing the program and data.

The memory 202 can be volatile memory (for example, RAM etc.) or non-volatile memory (for example, flash memory etc.), and includes at least a configuration definition area 202a for storing RAID configuration definition information, a buffer area (hereinafter referred to simply as “buffer”) 202b, and a cache memory area (hereinafter referred to simply as “cache memory”) 202c for storing a part of the data read from a lower device.

In the present embodiment, the memory 202 includes a configuration definition area 202a, a buffer 202b, and cache memory 202c. It is obvious that they can be independent storage devices.

The RAID configuration definition is a table for definition of the mapping relationship between an address on an interface with a host computer 203 and an address on the disk array 204 (or disk devices 204a, 204b, 204c, . . . ).

The disk array control apparatus 100 is connected to communicate with the host computer 203 as an upper device and the disk array 204 including a plurality of disk devices 204a, 204b, 204c, . . . . “To be connected to communicate” indicates “to be connected such that data can be communicated with each other”. For example, the connection can be made through a network such as a LAN etc., and using a dedicated line.

A disk array apparatus 200 according to the present embodiment includes the disk array control apparatus 100 and the disk array 204. The disk array apparatus 200 configures the RAID 6. The RAID 6 according to the present embodiment uses a P+Q method.

Upon receipt of a write request from the host computer 203, the disk array control apparatus 100 divides the data transmitted from the host computer 203 (hereinafter referred to as “write data”) into data of a predetermined size, and generates, for example, parity (parity P and Q) that have the mathematically orthogonal relation with each other. Then, striping data is generated from the write data and the parity data, and distributed and written to the disk array 204.

In the present embodiment, the striping data refers to data including the data obtained by dividing (striping) the write data in a predetermined size (for example, into blocks) and the parity data (parity P and Q) generated from the divided data.

Upon receipt of a read request from the host computer 203, the disk array control apparatus 100 checks whether or not there is data requested from the host computer 203 (hereinafter referred to as “read data”) in the cache memory 202c. If the memory 202 stores the read data, the data is read and transferred to the host computer 203.

If the cache memory 202c does not store the read data, then the disk array control apparatus 100 performs a staging process. First, it refers to the RAID configuration definition of the configuration definition area 201a, and confirms the location where the striping data including the read data is stored. Then, object striping data is read from the confirmed location (host computer 203).

Furthermore, the disk array control apparatus 100 confirms whether or not the read data is correct. If it is correct, then the disk array control apparatus 100 transfers the data to the host computer 203, and stores it in the cache memory 202c.

With the above-mentioned configuration, the data read unit 101, the first reference data generation unit 102, the second reference data generation unit 103, the true-false determination unit 104, and the data write unit 105 can be realized by allowing the CPU 201 to execute a predetermined program.

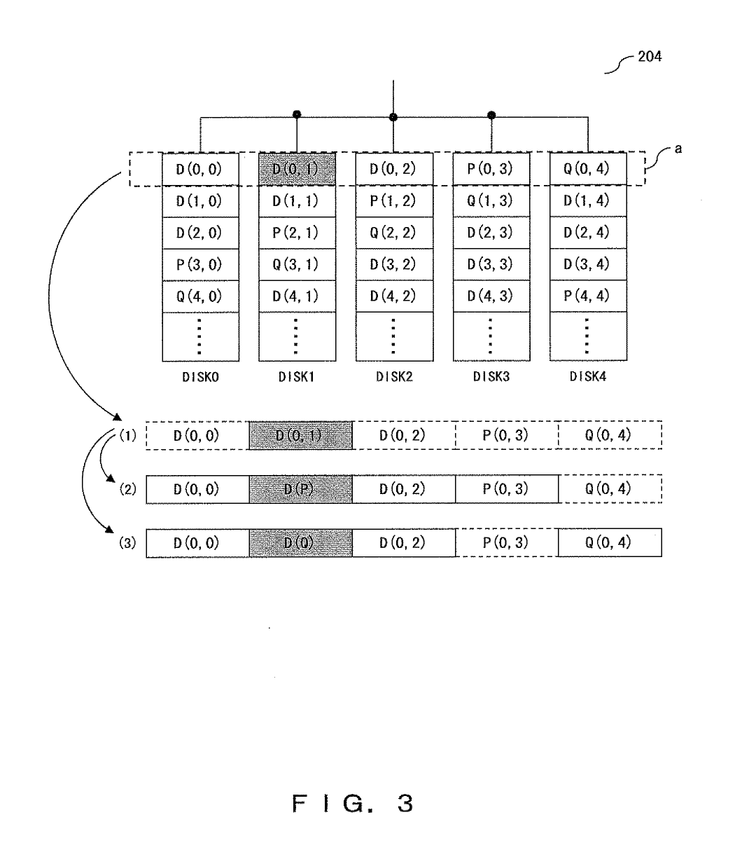

FIG. 3 shows the outline of the process of the disk array control apparatus 100 according to an embodiment of the present invention confirming whether or not read data is correct.

For a simple description, FIG. 3 shows the disk array 204 configured by five disk devices (disks 0 through 4) each of which stores distributed striping data formed by data D, and parity P and Q.

For example, each of the disks 0 through 4 stores D(0, 0), D(1, 0) D(2, 0), . . . , D(0, 1), D(1, 1), P(2, 1), . . . , D(0, 2), P(1, 2), Q(2, 2), . . . , P(0, 3), Q(1, 3), D(2, 3), . . . , and Q(0, 4), D(1, 4), D(2, 4), . . . .

Furthermore, each of the data groups D(0, 0), D(0, 1), D(0, 2), P(0, 3) and Q(0, 4); D(1, 0), D(1, 1), P(1, 2), Q(1, 3) and D(1, 4); D(2, 0), P(2, 1), Q(2, 2), D(2, 3) and D(2, 4); . . . is one piece of striping data.

Assume that the staging process is performed on the data D(0, 1). When the disk array control apparatus 100 starts the staging process, the disk array control apparatus 100 performs the following processes.

(1) reading striping data a including the data D(0, 1) as an object of the staging process from the disk array 204;

(2) reconstructing the data D(0, 1) from the data D(0, 0) and D(0, 2) other than the data D(0, 1) and the parity P(0, 3). The reconstructed data D(P) is the first reference data.

(3) reconstructing the data D(0, 1) from the data D(0, 0) and D(0, 2) other than the data D(0, 1) and the parity Q(0, 4). The reconstructed data D(Q) is the second reference data.

Then, the disk array control apparatus 100 compares the data D(0, 1), D(P), and D(Q), and stores the data determined that it is correct as a result of the comparison in the cache memory 202c.

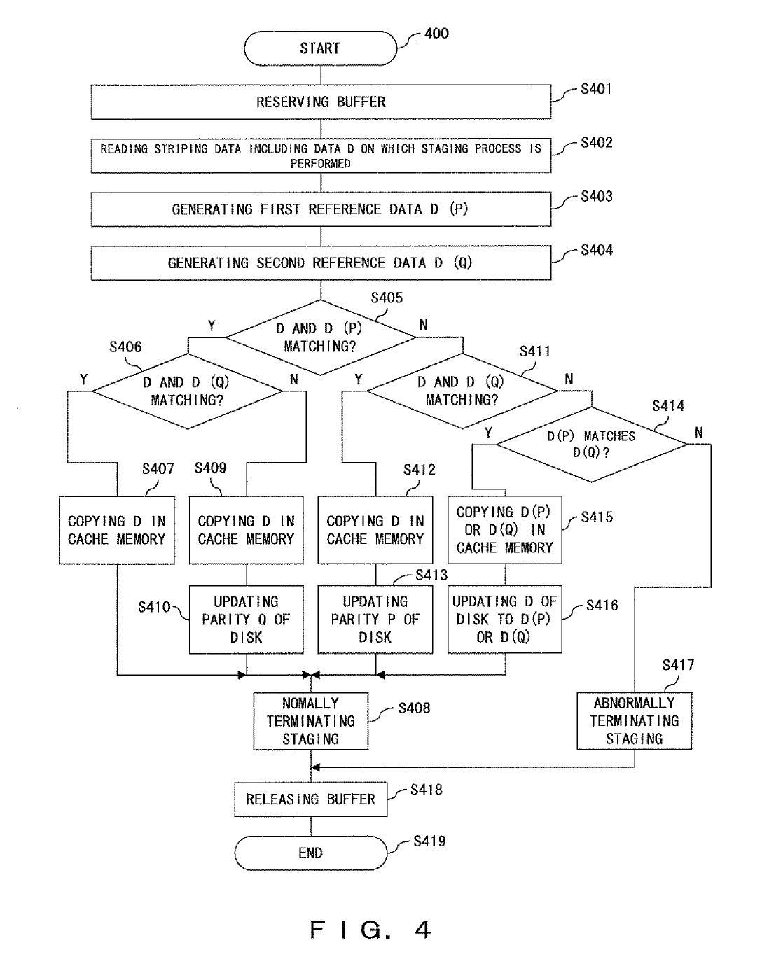

FIG. 4 is a flowchart showing a practical process of the staging of the disk array control apparatus 100 according to an embodiment of the present invention.

When the staging process is started, the disk array control apparatus 100 passes control to step S401.

In step S401, the disk array control apparatus 100 reserves the necessary buffer 202b in the memory 202 for staging. For example, it is used when the striping data (including the parity P and Q) read from the disk array 204 during staging is temporarily stored.

In step S402, the disk array control apparatus 100 reads the striping data including the data D as a staging object from the disk array 204, and stores the data in the buffer 202b.

In step S403, the disk array control apparatus 100 generates the first reference data D(P) for each piece of striping data read in step S402, and stores it in the buffer 202b.

In step S404, the disk array control apparatus 100 generates the second reference data D(Q) for each piece of striping data read in step S402, and stores it in the buffer 202b.

In step S405, the disk array control apparatus 100 compares the data D read in step S402 with the first reference data D(P) generated in step S403. If the data match each other as a result of the comparison, then control is passed to step S406.

In step S406, the disk array control apparatus 100 compares the data D read in step S402 with the second reference data D(Q) generated in step S404. If the data match each other as a result of the comparison, then control is passed to step S407.

In step S407, the disk array control apparatus 100 determines that the data D read in step S402 is correct, and stores the data D at a predetermined address of the cache memory 202c.

When the process in step S407 is completed, the disk array control apparatus 100 passes control to step S408, thereby normally terminating the staging process.

If the data do not match each other as a result of the comparison in step S406, the disk array control apparatus 100 passes control to step S409.

In step S409, the disk array control apparatus 100 determines that the data D read in step S402 is correct, and stores the data D at a predetermined address of the cache memory 202c.

In step S410, the disk array control apparatus 100 generates new parity Q from the data including the data D read in step S402, and updates the parity Q stored in the disk array control apparatus 100 using the new parity Q. Then, control is passed to step S408, thereby normally terminating the staging process.

If the data do not match each other as a result of the comparison in step S405, the disk array control apparatus 100 passes control to step S411.

In step S411, the disk array control apparatus 100 compares the data D read in step S402 with the second reference data D(Q) generated in step S404. If the data match each other as a result of the comparison, then control is passed to step S412.

In step S412, the disk array control apparatus 100 determines that the data D read in step S402 is correct, and stores the data D at a predetermined address of the cache memory 202c.

In step S413, the disk array control apparatus 100 generates new parity P from the data including the data D read in step S402, and updates the parity P stored in the disk array control apparatus 100 using the new parity P. Then, control is passed to step S408, thereby normally terminating the staging process.

If the data do not match each other as a result of the comparison in step S411, the disk array control apparatus 100 passes control to step S414.

In step S414, the disk array control apparatus 100 compares the first reference data D(P) generated in step S403 with the second reference data D(Q) generated in step S404. If the data match each other as a result of the comparison, control is passed to step S415.

In step S415, the disk array control apparatus 100 recognizes one of the first reference data D(P) and the second reference data D(Q) as correct data. In the present embodiment, for example, the disk array control apparatus 100 determines that the first reference data D(P) is correct data. Then, it stores the first reference data D(P) in the cache memory 202c.

In step S416, the disk array control apparatus 100 updates the data D stored in the disk array control apparatus 100 using the first reference data D(P) or the second reference data D(Q). In the present embodiment, the data D is updated using the first reference data D(P). Then, control is passed to step S408, and the staging process is normally terminated.

If the data do not match each other as a result of the comparison in step S414, the disk array control apparatus 100 passes control to step S417, thereby abnormally terminating the staging process.

When the staging process terminates in step S408 or S417, the disk array control apparatus 100 passes control to step S418, and releases the area of the buffer 202b reserved in step S401. When the buffer 202b is completely released, the disk array control apparatus 100 passes control to step S419, and completes the staging process.

In the above-mentioned staging process, when at least two or more pieces of data match among the desired data, the first reference data, and the second reference data, it is determined that the matching data are correct and the staging process is performed. However, when only two pieces of data match, the matching data is overwritten by the non-matching data, thereby recovering the consistency of the striping.

That is, if the non-matching data is the data D, the data D stored in the disk array 204 is updated by the non-matching data D. If the non-matching data is the first reference data D(P), new parity P is generated, and the parity P stored in the disk array 204 is updated by the new parity P. If the non-matching data is the second reference data D(Q), new parity Q is generated, and the parity Q stored in the disk array 204 is updated by the new parity Q.

As described above, the disk array control apparatus 100 according to the present embodiment generates the first reference data D(P) and the second reference data D(Q) from the striping data including the data D on which the staging process is performed. As a result of the comparison, it is determined that at least two pieces of matching data are correct, and the data is stored in the cache memory 202c.

As a result, it is confirmed whether or not the data D (data D on which the staging process is performed) read from the disk array 204 is correct. Thus, the staging process can be performed only on the correct data.

When the first reference data D(P) matches the second reference data D(Q), it is determined that the matching data are correct and the staging process is performed on the data although the read data D is not correct. Therefore, the read data D can be appropriately corrected.

What is claimed is:

1. A disk array control apparatus which generates a first error correction code and a second error correction code from predetermined data, distributes and stores the predetermined data and the first and second error correction codes in a lower device, and holds a part of data stored in the lower device in cache memory, comprising:
a data read unit reading from the lower device, at a read request from an upper device, predetermined data including the requested data, a first error correction code and a second error correction code generated from the predetermined data;
a first reference data generation unit generating first reference data from data read by the data read unit and excluding the requested data, and the first error correction code;
a second reference data generation unit generating second reference data from the data read by the data read unit and excluding the requested data, and the second error correction code;
a true-false determination unit comparing the requested data read by the data read unit, the first reference data, and the second reference data, and determining whether or not the requested data read by the data read unit is correct on a basis of a result of the comparison; and
a data write unit storing data recognized as correct data by the true-false determination unit in the cache memory.

2. The apparatus according to claim 1, wherein
the true-false determination unit determines that the requested data is correct when the requested data matches the first reference data or the second reference data.

3. The apparatus according to claim 1, wherein
the true-false determination unit determines that matching data are correct when two or more of the requested data, the first reference data, and the second reference data match.

4. A disk array apparatus which generates a first error correction code and a second error correction code from predetermined data, distributes and stores the predetermined data and the first and second error correction codes in a disk array having a plurality of disk device s, and holds a part of data stored in the disk array in cache memory, comprising:
a data read unit reading from the disk array, at a read request from an upper device, predetermined data including the requested data, a first error correction code and a second error correction code generated from the predetermined data;
a first reference data generation unit generating first reference data from data read by the data read unit and excluding the requested data, and the first error correction code;
a second reference data generation unit generating second reference data from the data read by the data read unit and excluding the requested data, and the second error correction code;
a true-false determination unit comparing the requested data read by the data read unit, the first reference data, and the second reference data, and determining whether or not the requested data read by the data read unit is correct on a basis of a result of the comparison; and
a data write unit storing data recognized as correct data by the true-false determination unit in the cache memory.

5. The apparatus according to claim 4, wherein
the true-false determination unit determines that the requested data is correct when the requested data matches the first reference data or the second reference data.

6. The apparatus according to claim 4, wherein
the true-false determination unit determines that matching data are correct when two or more of the requested data, the first reference data, and the second reference data match.

7. A staging method used to direct a disk array control apparatus which generates a first error correction code and a second error correction code from predetermined data, distributes and stores the predetermined data and the first and second error correction codes in a lower device, and holds a part of data stored in the lower device in cache memory, comprising:
reading from the lower device, at a read request from an upper device, predetermined data including the requested data, a first error correction code and a second error correction code generated from the predetermined data;
generating first reference data from predetermined data excluding the requested data and the first error correction code;
generating second reference data from the predetermined data excluding the requested data, and the second error correction code;
comparing the requested data, the first reference data, and the second reference data, and determining whether or not the requested data is correct on a basis of a result of the comparison; and
storing data recognized as correct data in the cache memory.

8. The method according to claim 7, wherein
it is determined that the requested data is correct when the requested data matches the first reference data or the second reference data.

9. The method according to claim 7, wherein
it is determined that matching data are correct when two or more of the requested data, the first reference data, and the second reference data match.
